(19) United States
(12) Patent Application Publication
(10) Pub. No.: US 2003/0220917 A1
(43) Pub. Date: Nov. 27, 2003

(54) Contextual search

(76) Inventors: Max Copperman, Santa Cruz, CA (US); Samir Mahendra, Sunnyvale, CA (US); Scott B. Huffman, Redwood City, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/382,104

(22) Filed: Mar. 5, 2003

Related U.S. Application Data
(60) Provisional application No. 60/369,898, filed on Apr. 3, 2002.

(51) Int. Cl. G06F 17/30

(52) U.S. Cl. 707/3

(57) ABSTRACT

A customer relationship management (CRM) or other content provider system and method use a set of predetermined terms organized into predetermined groups. A set of search queries is generated using search templates, ordered generally from approximately more specific to approximately more general, including combinations of such groups. A user-provider session generates session context using, among other things, user query language, user response language, a user selection, or a user attribute. Each search template specifies which ones of the groups require at least one corresponding term in the session context to be present in a document for that document to satisfy a search query generated from that search template. In one example, some groups may include words or terms other than the predetermined terms. Such other words or terms may be defined by other characteristics, such as by their frequency of occurrence in the content. In further examples, the search templates require not only the presence of terms from various combinations of groups, but also specify order, proximity, and/or other relational requirements between two or more groups.

### CROSS-REFERENCE TO RELATED APPLICATIONS

This patent application claims the benefit of priority, under 35 U.S.C. Section 119(e), to Copperman et al. U.S. Provisional Patent Application Serial No. 60/369,898, entitled “CONTEXTUAL SEARCH,” filed on Apr. 3, 2002 (Attorney Docket No. 01546.018PRV).

This patent application is also related to: Bode et al. U.S. patent application Ser. No. 10/023,433 entitled TEXT SEARCH ORDERED ALONG ONE OR MORE DIMENSIONS, filed Dec. 17, 2001 (Attorney Docket No. 01546.014US1), which is incorporated herein by reference in its entirety; and Copperman et al. U.S. patent application Ser. No. 10/047,446 entitled EFFICIENT AND COST-EFFECTIVE CONTENT PROVIDER FOR CUSTOMER RELATIONSHIP MANAGEMENT (CRM) OR OTHER APPLICATIONS, filed on Jan. 14, 2002 (Attorney Docket No. 01546.015US1), which is also incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This document relates generally to among other things, computer-based content provider systems, devices, and methods and particularly, but not by way of limitation, to a contextual search in the same.

### BACKGROUND

A computer network, such as the Internet or World Wide Web, typically serves to connect users to the information, content, or other resources that they seek. Web content, for example, varies widely both in type and subject matter. Examples of different content types include, without limitation: text documents; audio, visual, and/or multimedia data files. A particular content provider, which makes available a predetermined body of content to a plurality of users, must steer a member of its particular user population to relevant content within its body of content.

For example, in an automated customer relationship management (CRM) system, the user is typically a customer of a product or service who has a specific question about a problem or other aspect of that product or service. Based on a query or other request from the user, the CRM system must find the appropriate technical instructions or other documentation to solve the user's problem. Using an automated CRM system to help customers is typically less expensive to a business enterprise than training and providing human applications engineers and other customer service personnel. According to one estimate, human customer service interactions presently cost between $15 and $60 per customer telephone call or e-mail inquiry. Automated Web-based interactions typically cost less than one tenth as much, even when accounting for the required up-front technology investment.

One ubiquitous navigation technique used by content providers is the Web search engine. A Web search engine typically searches for user-specified text, either within a document, or within separate metadata associated with the content. Language, however, is ambiguous. The same word in a user query can take on very different meanings in different context. Moreover, different words can be used to describe the same concept. These ambiguities inherently limit the ability of a search engine to discriminate against unwanted content. This increases the time that the user must spend in reviewing and filtering through the unwanted content returned by the search engine to reach any relevant content. As anyone who has used a search engine can relate, such manual user intervention can be very frustrating. User frustration can render the body of returned content useless even when it includes the sought-after content. When the user's inquiry is abandoned because excess irrelevant information is returned, or because insufficient relevant information is available, the content provider has failed to meet the particular user's needs. As a result, the user must resort to other techniques to get the desired content. For example, in a CRM application, the user may be forced to place a telephone call to an applications engineer or other customer service personnel. As discussed above, however, this is a more costly way to meet customer needs. For these and other reasons, the present inventors have recognized the existence of an unmet need to provide improved efficient and cost-effective tools and techniques for guiding a user to needed content.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally one example of a conceptualization of an at least partially automated content provider system that steers a user toward needed content.

FIG. 2 is a schematic illustration of one example of a conceptualization of an organizational schema for categorizing terms according to Activity, Object, Product, and Symptom groups.

FIG. 3 is a block diagram illustrating generally, by way of example, but not by way of limitation, portions of a content provider that performs retrieval ordered along one or more dimensions based at least in part on session context from a user-provider session.

FIG. 4 is a schematic diagram illustrating generally one conceptualization allowing for different (single or multi-dimensioned) ordered lists of search queries or other search strategies, which are used depending on one or more characteristics of the user query or other session context from the user session.

FIG. 5 is a flow chart illustrating generally, by way of example, but not by way of limitation, one technique for deciding which unrecognized words should be used in combination with the search queries using recognized terms, such as those illustrated in Table 1.

FIG. 6 is a flow chart illustrating generally, by way of example, but not by way of limitation one conceptualization of another approach to using unrecognized words in the search queries.

FIG. 7 is a block diagram illustrating generally, by way of example, but not by way of limitation, one conceptualization of portions of a content provider using ordered search queries to formulate and/or present alternative and/or broadening queries to a user.

FIG. 8 is a schematic illustration of a portion of a display of a user interface, resulting from a user query that includes a single Object-type recognized term.

FIG. 9 is a schematic illustration of a portion of a display of a user interface, resulting from a user query that includes another single Object-type recognized term.

FIG. 10 is a schematic illustration of a portion of a display of a user interface, resulting from a user query that includes a single Activity-type recognized term.

FIG. 11 is a schematic diagram illustrating generally one example of how session context is divided into classes, with each class capable of independently defining a display strategy.

FIG. 12 is a screen shot illustrating a portion of a computer display including alternate or broadening search queries ordered along one or more dimensions.

### DETAILED DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconcilable inconsistencies, the usage in this document controls.

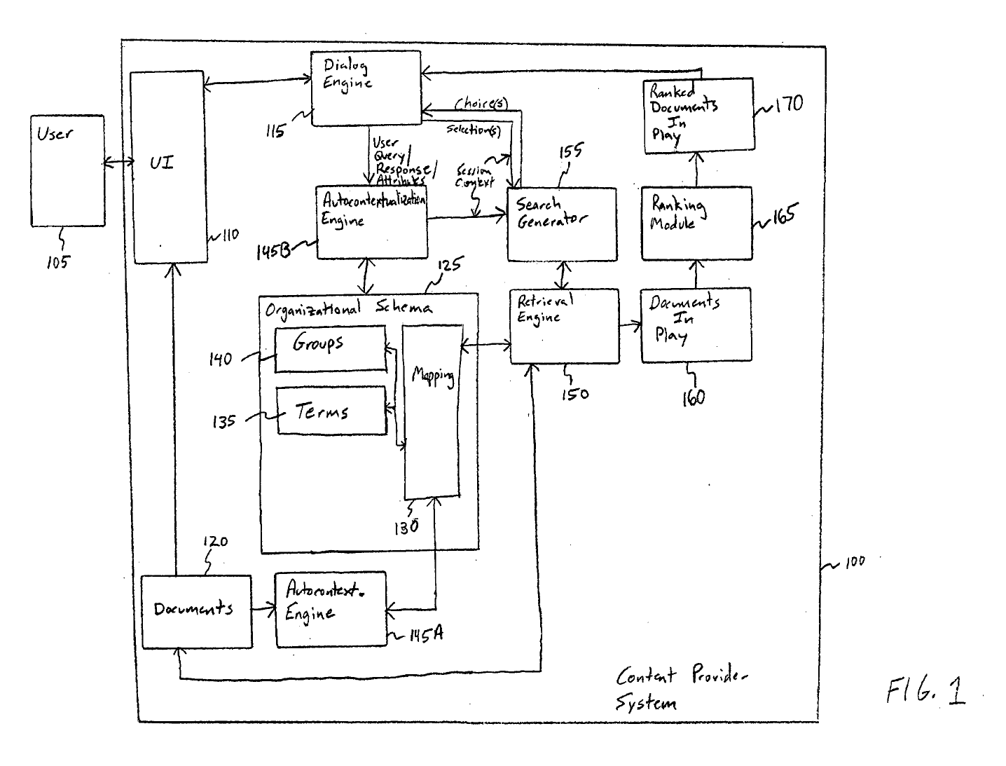

FIG. 1 is a block diagram illustrating generally one example of a conceptualization of an at least partially automated content provider system 100 that steers a user 105 toward needed content. In this example, user 105 is linked to content provider 100 by a communications network, such as the Internet, using a computer Web-browser or any other suitable access modality. Content provider 100 includes, among other things, a web-browser display or other user interface 110 for receiving information from and providing information to user 105. In one example, content provider 100 includes a dialog engine 115 for carrying out an intelligent dialog session with user 105 to guide user 105 toward needed documents (or other content) 120, such as described in commonly assigned Fratkina et al. U.S. patent Ser. No. 09/798,964 entitled “A SYSTEM AND METHOD FOR PROVIDING AN INTELLIGENT MULTI-STEP DIALOG WITH A USER,” filed on Mar. 6, 2001, which is incorporated by reference herein in its entirety, including its description of a dialog engine. The session between the user and the content provider creates session context, which includes, among other things, information obtained from the user. Such information obtained from user 105 includes, among other things, a textual or other language-based user query, a prompted user response or user-selection from presented choices, and/or user attributes obtained from the same user 105 or other users during the same or a previous user-provider session.

In this example, content provider 100 includes an organizational schema 125 for organizing documents 120 according to a mapping 130 of such documents 120 to terms (or concept nodes) 135, which are organized into taxonomies or other groups 140. One example of using taxonomies in a multidimensional knowledge map is described in commonly assigned Copperman et al. U.S. patent application Ser. No. 09/594,083, entitled SYSTEM AND METHOD FOR IMPLEMENTING A KNOWLEDGE MANAGEMENT SYSTEM, filed on Jun. 15, 2000, which is incorporated herein by reference in its entirety, including its description of a multiple taxonomy knowledge map and techniques for using the same. The Copperman et al. U.S. patent application Ser. No. 09/594,083 is also incorporated herein by reference for its description of examples of a wide variety of different types of knowledge containers or other contents or resources, all of which are included and represented herein by documents 120. In addition to documents per se, documents 120 may also include knowledge containers that include, among other things: document (e.g., text); multimedia (e.g., sound and/or visual content); e-resource (e.g., description and link to online information or services); question (e.g., a user query); answer (e.g., a CRM answer to a user question); previously-asked question (PQ; e.g., a user query and corresponding CRM answer); knowledge consumer (e.g., user information); knowledge provider (e.g., customer support staff information); product (e.g., product or product family information). It is important to note that, in this document, content is not limited to electronically stored content, but also allows for the possibility of a human expert providing needed information to the user. For example, a retrieved document 120 could include information about particular customer service personnel and their corresponding areas of expertise. Based on this descriptive information, user 105 could select one or more such human information providers, and be linked to that provider (e.g., by e-mail, Internet-based telephone or videoconferencing, by providing a direct-dial telephone number to the most appropriate expert, or by any other suitable communication modality).

In the example of FIG. 1, mapping 130 is performed using an autocontextualization engine 145A or other document classifier. One example of a device and method(s) for implementing an autocontextualization engine 145A and document classifier is described in commonly assigned Ukrainczyk et al. U.S. patent application Ser. No. 09/864,156, entitled A SYSTEM AND METHOD FOR AUTOMATICALLY CLASSIFYING TEXT, filed on May 25, 2001, which is incorporated herein by reference in its entirety, including its disclosure of a suitable example of systems and methods for automatic text classification. The same or different autocontextualization engine 145B similarly maps one or more user queries to such terms 135 or concept nodes, such as by using language in the user query, prompted user responses, and/or user attributes resulting from the user-provider dialog session. This confirms certain terms 135 as being relevant to the user's needs and/or excludes other terms 135 as being not relevant to the user's needs. This also creates session context. By constraining and/or otherwise focusing the user's search using such an organizational schema 125 as an intermediary between the user 105 and the documents 120 or other content, content provider 100 guides user 105 toward needed content.

In this example, content provider 100 includes a retrieval engine 150 that retrieves one or more documents 120 deemed relevant to the user's needs, if any. The retrieval engine 150 uses, among other things, one or more constraints to one or more portions of mapping 130 within organizational schema 125. One example of a retrieval engine is described in commonly assigned Copperman et al. U.S. patent application Ser. No. 09/912,247, entitled SYSTEM AND METHOD FOR PROVIDING A LINK RESPONSE TO INQUIRY, filed Jul. 23, 2001, which is incorporated by reference herein in its entirety, including its description of a retrieval system and method. Search generator 155 formulates one or more searches for content. Such searches are performed by retrieval engine 150, and are capable of being based at least in part on constraints and other session context generated by the autocontextualization engine 145B and/or dialog engine 115. In addition to being capable of using such constraints, in one embodiment, such searches are also based at least in part on textual searches in the documents 120. Inputs to such textual searches may include, among other things, language from a user query or language obtained from user selections of presented textual search inputs. In a “guided-search” embodiment, such user selections are typically obtained in response to presented choices of proposed search terms that are provided by search generator 155 to user 105. The documents-in-play 160 retrieved by retrieval engine 150 are ranked (e.g., according to perceived relevance to the user's needs) by ranking module 165. This yields ranked documents-in-play 170. User interface 110 presents to user 105 ranked indications of such documents-in-play 160. Such indications may be accompanied by contextual information, including key-word-in-context presentation of one or more concept terms or other search terms, as they appear in that document.

Examples of a guided-search implementation are described further in commonly-assigned Copperman et al. U.S. patent application Ser. No. 10/047,446 entitled EFFICIENT AND COST-EFFECTIVE CONTENT PROVIDER FOR CUSTOMER RELATIONSHIP MANAGEMENT (CRM) OR OTHER APPLICATIONS, filed on Jan. 14, 2002 (Attorney Docket No. 01546.015US1), which is incorporated herein by reference in its entirety, including its description of a guided-search implementation and an accompanying user interface. As described in that document, in one example, the documents 120 are automatically processed to extract candidate terms. These candidate terms are presented by a user interface to a human knowledge engineer, who selects at least some of these candidate terms to be used as terms 135 within organizational schema 125. The knowledge engineer also categorizes the selected terms 135 into groups 140, although, in one embodiment, such categorization is performed at least partially automatically (e.g., using part-of-speech or other automated or computer-assisted linguistic analysis), with the knowledge engineer confirming or recategorizing such terms 135, as appropriate.

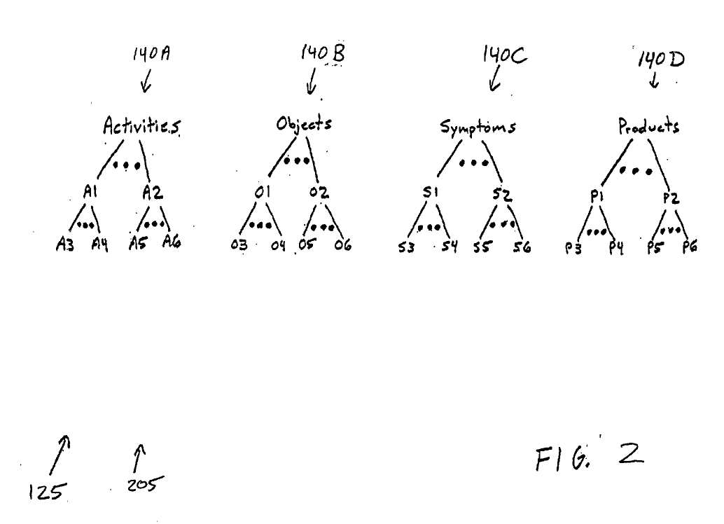

Among other things, Copperman et al. U.S. patent application Ser. No. 10/047,446 describes a guided search implementation using a reduced set of taxonomies or other groups 140 that can be at least partially reused for a different entity's content provider implementation. In one example, groups 140 of FIG. 1 include Activity, Object, Product, and Symptom groups, such as described in the above-incorporated Copperman et al. U.S. patent application Ser. No. 10/047,446 and incorporated herein by reference. In this example, therefore, terms 135 are categorized according to Activity, Object, Product, and Symptom groups, as illustrated schematically in FIG. 2. Such specific groups (e.g., Activity, Object, Product, and Symptom) are provided by way of illustrative example, and not by way of limitation. In an alternative illustrative example, groups 140 instead include Sales, Legal, and Accounting groups. In yet another alternative illustrative example, groups 140 include Symptom, Disease, Drug Therapy, Medical Therapy, and Diagnostic Technique groups. Again, such specific examples of different groups 140 is illustrative only. In general, a wide-variety of applicable groups may be used, and the exact choice of the particular different groups selected may depend on the particular content base and/or the particular user base of the content provider system 100.

In the example of FIG. 2, organizational structure 125 includes a knowledge map 205 or any other suitable organizational schema. In this example, the organizational schema includes four primary groups 140A-D. These primary groups 140A-D respectively pertain to “Activities,” “Objects,” “Symptoms,” and “Products.” In this example, groups 140A-D are illustrated as hierarchical directed acyclical graph (DAG) taxonomies 140. However, in other examples, groups 140A-D include nonhierarchical lists or groups 140 that may be either ordered or unordered. In FIG. 2, the Activities group 140A includes terms 135 represented by concept nodes A1, A2 . . . , AN, the Objects group 140B includes terms 135 represented by concept nodes O1, . . . , ON, the Symptoms group 140C includes terms 135 represented by concept nodes S1, S2, . . . , SN, and the Products group 140D includes terms 135 represented by concept nodes P1, P2, . . . , PN. In practice, each concept node in a hierarchical embodiment may have fewer or greater (or even no) underlying subconcept nodes, regardless of how illustrated in FIG. 2, and may even be grouped without any hierarchy and even without any ordering. Moreover, any other suitable hierarchical or nonhierarchical organizational schema or classification may be substituted for any of the concept nodes discussed herein.

To further illustrate the above example, for a CRM content provider 100 for guiding a customer of a software package to appropriate documentation about its use, concept nodes A1, A2, . . . , AN correspond to relevant activity-type terms 135 (e.g., “backup,38 “install,” etc.), concept nodes O1, O2, . . . , ON correspond to those relevant object-type terms 135 that aren't more specifically identified as product-type terms 135 (e.g., “laser printer,” “server,” etc.), concept nodes S1, S2, . . . , SN correspond to relevant symptom-type terms 135 (e.g., “crash,” “error,” etc.), and concept nodes P1, P2, . . . , PN correspond to product-type terms 135 (which may include goods and/or services, e.g., “WordPerfect,” “Excel,” etc.).

In this example, each primary group concept node A1, A2, . . . , AN, and O1, O2, . . . , ON, and S1, S2, . . . , SN, and P1, P2, . . . , PN corresponds to a feature or term 135 (e.g., a word or phrase, together with its synonyms, if any), or set of features, that exists in at least one document (or other content resource) in the body of documents D1, D2, . . . , DN that are to be organized according to the schema 125 illustrated in FIG. 2 and made available to user 105 of content provider 100. For example, if the particular activity at concept node A1 pertains to the activity feature “backup” (including “back up” and “back-up;” in this example, such synonyms are also deemed to be evidence for the concept “backup”), then at least one of “backup,” “back up” and “back-up” are found in at least one of documents D1, D2, . . . , DN. Therefore, this example avoids creating concept nodes that do not have at least one corresponding document tagged thereto. In this example, all documents including one of the evidence terms “backup,” “back up” and “back-up” will be tagged to the concept node A1.

FIG. 2 shows only Activities, Objects, Symptoms and Products groups 140A-D. In one example, these are the only primary groups 140 used to provide an organizational structure 500 for classifying the documents D1, D2, . . . , DN. In another example, other primary groups 140 are used in addition to the illustrated Activities, Objects, Symptoms and Products groups 140A-D. In each of these examples, hierarchical Activities, Objects, Symptoms and Products groups 140A-D may be used, as illustrated. Alternatively, nonhierarchical and even non-ordered Activities, Objects, Symptoms and Products lists or groups 140 of respective concept nodes A1, A2, . . . , AN, and O1, O2, . . . , ON, and S1, S2, . . . , SN, and P1, P2,. . . , PN are substituted for the hierarchical directed acyclical graphs (DAGs) illustrated in FIG. 2. In yet a further example, the Products and Objects groups are merged into a single Objects group that includes both product and non-product objects. In yet another example, fewer (e.g., no “Symptoms” group) or even completely different primary groups are used. In a further example, such as described in the above-incorporated Copperman et al. U.S. patent application Ser. No. 10/047,446, groups 140 also include (in addition to the above-described Activities, Objects, Symptoms and Products primary groups 140A-D), derived groups that interrelate concept nodes from the same or different primary groups 140A-D.

In one example, user interface 110 provides, among other things, a guided-search such as described in the above-incorporated Copperman et al. U.S. patent application Ser. No. 10/047,446. This includes displaying terms 135 or features extracted from a user query, as well as suggesting related features for focusing or expanding the user's search, or for initiating an alternative search. In one example, an alternate search is suggested to user 105 upon a previous search returning no documents-in-play. In one further example, the suggested alternate searches are formulated so as to ensure that at least one document-in-play is returned.

User interface 110 is also capable of displaying indications of the returned and ranked documents in play 170. Moreover, in one example, user interface 110 is capable of displaying dialog prompts and receiving responsive user language or selections among presented choices, thereby generating session context for further guiding the user's search, such as described and/or incorporated above. During the guided search session, content provider 100 may receive from user 105 (e.g., in user queries, responses, or selections) or otherwise create session context that includes both: (1) recognized terms 135 or features that are mapped to concepts and categorized to respective groups 140; and/or (2) other unrecognized language.

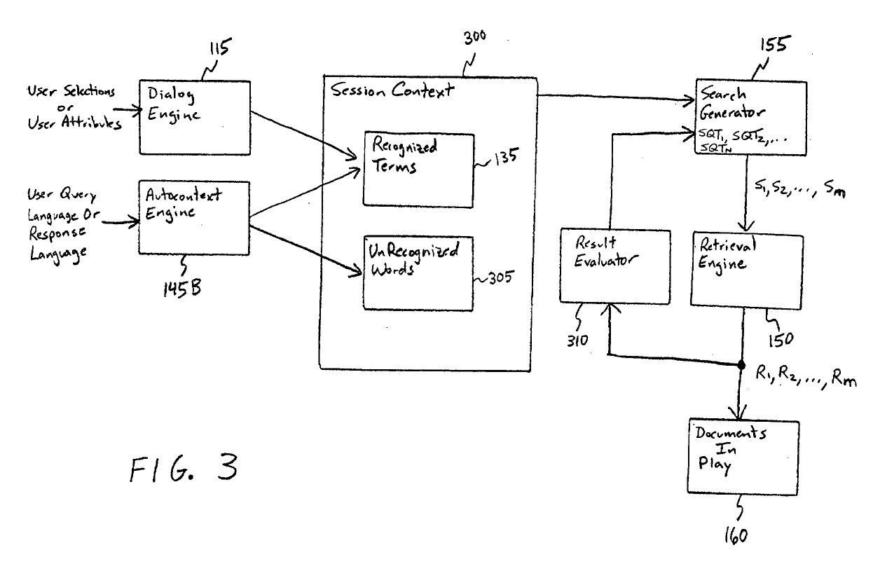

FIG. 3 is a block diagram illustrating generally, by way of example, but not by way of limitation, portions of a content provider 100 that performs retrieval ordered along one or more dimensions based at least in part on the user query language or other session context 300 from a user-provider session. In this example, user selections or user attributes are received by dialog engine 115 and mapped to recognized terms 135 of session context 300. User query language or response language is received by autocontextualization engine 145B; such language may include both recognized terms 135 and unrecognized words 305, both of which are included within session context 300. Based at least in part on all or a portion of such session context 300, search generator 155 formulates multiple search query templates SQT1, SQT2, . . . , SQTN ordered along one or more dimensions. In one example, these search query templates are generally ordered approximately from more specific to more general. User query language or other session context is used to formulate search queries S1, S2, . . . , SM ordered, corresponding to the search query templates, generally from more specific to more general. (There need not be a one-to-one correspondence between search queries and search query templates, as discussed below). Retrieval engine 150 serially executes the multiple search queries, yielding corresponding results R1, R2, . . . , RM. In one example, such results R1, R2, . . . , RM need not retrieve the documents matching the corresponding search query, but instead return only the number of documents matching the corresponding search query. In another example, the search results R1, R2, . . . , RM return both the number of documents matching the corresponding query, as well as such identifying and/or returning “documents-in-play” 160. In one example, result evaluator 310 evaluates each one of search results R1, R2, . . . , RM to determine whether the next search query in the ordered list of search queries S1, S2, . . . , SM should be executed by retrieval engine 150. In one example, in which the search queries S1, S2, . . . , SM are generally ordered approximately from more specific to more general, result evaluator 310 determines whether the number of returned documents in play 160 exceeds a desired minimum threshold (or falls between desired minimum and maximum thresholds). In one such example, the ordered search queries need not be submitted to and executed by retrieval engine 150 in the same order as the list of search queries S1, S2, . . . , SM. In one such illustrative example, the ordered list of search queries S1, S2, . . . , SM is submitted and executed using binary or other divide-and-conquer techniques to obtain a resulting number of documents-in-play 160 that within or close to the desired range of documents-in-play 160.

In one example, search queries S1, S2, . . . , SM are ordered using search query templates SQT1, SQT2, . . . , SQTN, which, in turn, are ordered using groups 140 corresponding to recognized terms 135 of organizational schema 125, where such recognized terms 135 are included in session context 300 because they were present in user query language, user response language, user selections, and/or user attributes. One example of a list of search query templates ordered along such a dimension that is based on the groups 140 corresponding to recognized terms 135 is illustrated in Table 1. In this example, groups 140 are the Activities, Objects, Products, and Symptoms groups described and/or incorporated above, which are respectively referred to in Table 1 by the corresponding letters “A,” “O,” “P,” and “S.” Table 1 includes search query templates that are generally ordered from approximately more specific to more general in that SQT1 through SQT10 are more specific than SQT11 through SQT17, which are more specific than SQT18 through SQT24, and SQT25 through SQT28 are the most general, though within each subgroup such as SQT1 through SQT10 one search query template is typically neither more specific nor more general than another. Note that Table 1 does not contain all possible search query templates (all possible combinations of A, O, P, and S). In this example, only those search query templates that are expected to return a coherent and relevant set of documents are embodied in the list of search query templates. For example, over a large number of possible relevant terms 135, it is believed that an Activity, Object, and Symptom (AOS), will more likely return a coherent and relevant set of documents in play 160 than an Activity, Activity, and an Activity (AAA). Therefore, in this example, the former is deemed a search query template worth offering to a user, the latter is not, so the former is included in the list of Table 1 and the latter is excluded.

TABLE 1
Example of Search Query Templates Ordered Along “Group” Dimension

| Search Query | | Search Query | |
|---|---|---|---|
| Template Label | Groups | Template Label | Groups |
| SQT1 | POAS | SQT15 | OOS |
| SQT2 | PAAS | SQT16 | OOA |
| SQT3 | PASS | SQT17 | OOP |
| SQT4 | OAAS | SQT18 | AP |
| SQT5 | OASS | SQT19 | AO |
| SQT6 | OOAS | SQT20 | AS |
| SQT7 | OOSS | SQT21 | PS |
| SQT8 | PPSA | SQT22 | OS |
| SQT9 | PPOS | SQT23 | PO |
| SQT10 | PPOA | SQT24 | OO |
| SQT11 | APS | SQT25 | S |
| SQT12 | AOS | SQT26 | A |
| SQT13 | POS | SQT27 | P |
| SQT14 | POA | SQT28 | O |

In Table 1, for example, search query template SQT1 is used if recognized terms 135 in the session context 300 include a Product term, an Object term, an Activity term, and a Symptom term, without respect to the order in which such terms appear in the user query language, user response language, user selections, and/or user attributes. If the session context 300 does not include terms corresponding to all four of these groups specified in search query template SQT1, then search generator 155 proceeds to the next search query template, e.g., SQT2. If the session context 300 includes multiple recognized terms 135, such multiple search queries can be formulated using the search query template SQT1, then such multiple search queries corresponding to the search query template SQT1 are formulated before proceeding to the search query template SQT2.

As an illustrative example, suppose that user query language “changing language from German to English fails” is received by autocontexualization engine 145B, resulting in session context 300 that includes the recognized terms 135 “change,” which has been categorized as an Activity, “fails,” which has been categorized as a Symptom, “language,” which has been categorized as an Object, “German,” which has been categorized as an Object, and “English,” which has been categorized as an Object. Using search query templates as ordered in the example of Table 1, the following sequence of search queries is formulated:

1. SQT6=(OOAS)=“change” AND “language” AND “english” AND “fails”=S1

2. SQT6=(OOAS)=“change” AND “language” AND “german” AND “fails”=S2

3. SQT6=(OOAS)=“change” AND “german” AND “english” AND “fails”=S3

4. SQT12=(AOS)=“change” AND “language” AND “fails”=S4

5. SQT12(AOS)=“change” AND “german” AND “fails”=S5

6. SQT12=(AOS)=“change” AND “english” AND “fails”=S6

7. SQT15=(OOS)=“language” AND “german” AND “fails”=S7

8. SQT15=(OOS)=“language” AND “english” AND “fails”=S8

9. SQT15=(OOS)=“german” AND “english” AND “fails”=S9

10. SQT16=(OOA)=“change” AND “language” AND “english”=S10

In this example, the first search query, S1, returns the number of documents that include “change” AND “language” AND “english” AND “fails,” the second search query, S2, returns the number of documents that include “change” AND “language” AND “german” AND “fails,” etc. The search queries S1, S2, . . . , SM may be sent in sequence to be executed by the retrieval engine, receiving the result from one before sending the next, or may be sent as a group, receiving all the results at the same time. In one example, after all search queries corresponding to a particular search query template (e.g., after the first three search queries, S1, S2, and S3 corresponding to the SQT6 template) are executed by retrieval engine 150, result evaluator 310 compares the number of returned documents against a minimum threshold (or minimum and maximum thresholds) to determine whether the number of returned documents is within the desired range. If the number of returned documents is within the desired range, then the documents-in-play 160 are returned to the user 105; otherwise, one or more further search queries corresponding to one or more subsequent search query templates in the ordered list are formulated by search generator 155 and executed by retrieval engine 150.

In another example, search queries are formulated by search generator 155 and executed by retrieval engine 150 to return the number of documents that satisfy each executed search query. In this example, result evaluator 310 directs search generator 155 and retrieval engine 150 to continue to formulate and execute search queries until a predetermined number (e.g., 5) of those executed search queries return at least one corresponding document. At that point, the documents-in-play 160 resulting from such search queries are returned to the user 105.

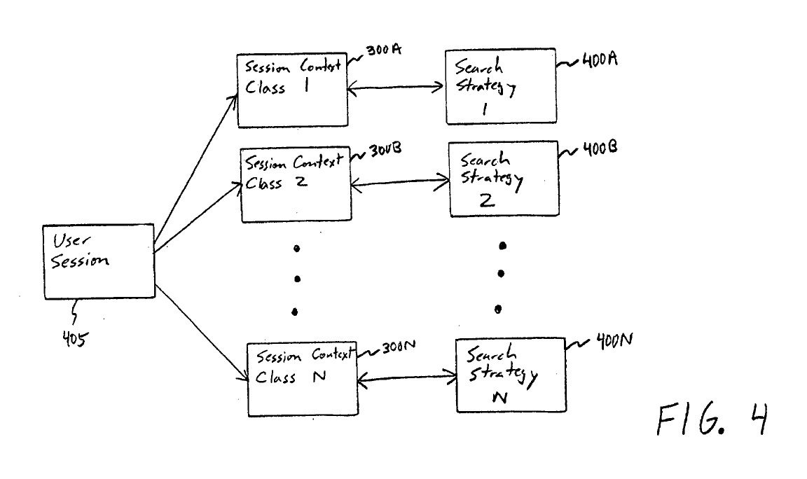

FIG. 4 is a schematic diagram illustrating generally one conceptualization allowing for different (single or multi-dimensioned) ordered lists of search query templates or other search strategies 400A-N, which are used depending on one or more characteristics of the user query or other session context 300A-N from the user session 405. In one example, the session contexts 300A-N are differentiated from each other by classifying the user query into query classes based on the number of recognized terms in the user query. One example of this is described in Bode et al. U.S. patent application Ser. No. 10/023,433 entitled TEXT SEARCH ORDERED ALONG ONE OR MORE DIMENSIONS, filed Dec. 17, 2001 (Attorney Docket No. 01546.014US1), which is incorporated herein by reference in its entirety, including its description of query classes and related techniques.

In other examples, one or more other criteria are additionally or alternatively used to classify the session context 300 to select a particular search strategy. In one example, session context 300 is classified according to whether a recognized Symptom term is present, and a particular search strategy is selected based at least in part on such a classification of session context 300. In a further example, session context 300 is classified according to which particular group 140 or groups correspond to recognized terms (if any) in the user query or other session context 300. In another example, session context 300 is classified according to the number of documents returned by retrieval engine 150 for each recognized term 135. In one such example, the particular one of search strategies 400A-N that is selected depends at least in part on the number of documents returned by the least common one of recognized terms 135, and/or which one of the Activity, Objects, Products, or Symptoms groups 140 is associated with the least common one of recognized terms 135. In another example, session context 300 is classified according to the number of documents returned by retrieval engine 150 using textual searches for one or more of unrecognized words 305. In yet another example, session context 300 is classified according to the use of one or more key words or phrases (e.g., in the user query language) that are not among the recognized terms 135 (e.g., “how do I,” “can I,” etc.). In yet a further example, session context 300 is classified according to recognized patterns in user query language or other session context 300, such as lists of multiple questions within a single user query, a history-type query (e.g., “before. and now . . . , ” etc.).

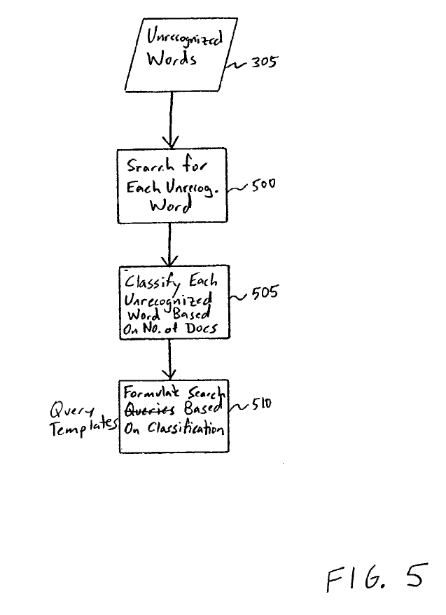

Although Table 1 illustrates search query templates ordered along a dimension corresponding to groups 140 associated with recognized terms 135, such search query templates may additionally or alternatively be ordered along one or more other dimensions. In one example, the search query templates are also ordered along a dimension using unrecognized words 305 in addition to the specified groups 140 associated with the recognized terms 135. FIG. 5 is a flow chart illustrating generally, by way of example, but not by way of limitation, one technique for deciding which unrecognized words 305 should be used in combination with the search query templates using recognized terms 135, Table 1. In the example of FIG. 5, unrecognized words 305 are first individually textually searched, at 500, using retrieval engine 150 (prefiltering may, but need not, be used to remove certain ubiquitous words, referred to as “stopwords”). For each unrecognized word 305 this yields a number of documents in which that unrecognized word 305 appears; the particular documents themselves may, but need not, be identified or retrieved. At 505, each unrecognized word 305 that was searched is classified based on, among other things, the number of documents in which that word appears. In one illustrative example, if the unrecognized word 305 does not appear in any document, it is classified as “Absent,” if it appears in between 1 and about 15 documents, it is classified as “Rare,” if it appears in between about 16 and about 75 documents, it is classified as “Middling,” if it appears in between about 76 and about 300 documents, it is classified as common, and if it appears in over about 300 documents, it is classified as ubiquitous; these classifications are respectively represented as “A,” “R,” “M,” “C,” and “U.” At 510, search queries are formulated using, among other things, an ordered sequence of search query templates that includes classification of the unrecognized words 305 which are represented as absent, rare, middling, common, or ubiquitous using the corresponding designations “W(A),” “W(R),” “W(M),” “W(C),” and “W(U).”

In one illustrative example, if a rare word “W(R)” is included in session context 300, then search query template SQT1=POAS of Table 1 is expanded to first return documents-in-play 160 that include the rare word, W(R). In this example, the search query template SQT1 is expanded into SQT1A=POASW(R) followed by SQT1B=POAS. As described above with respect to the recognized terms 135, if several rare words are included in session context 300, then the several rare words trigger several search queries S1A, S1B, etc. corresponding to the search query template SQT1. These different search queries test for the presence of the different rare words W(R). In a further example (again generally ordering search query templates from approximately more specific to approximately more general), subsequent query templates test for the presence of more common words. In such an example, the search query template SQT1 is expanded into SQT1A=POASW(R), SQT1B=POASW(M), SQT1C=POASW(C), and the original SQT1=POAS. (It is typically not worthwhile to test for the presence of ubiquitous words, as they will not further discriminate among the documents in play, hence SQT1D=POASW(U) is not included in the list.) Similarly, the search query template SQT2 is expanded into SQT2A=PAASW(R), SQT2B=PAASW(M), SQT2C=PAASW(C), and SQT2=PAAS. Similarly, the search query template SQT11, for example, is expanded into SQT11A APSW(R), SQT11B=APSW(M), SQT11C=APSW(C), and SQT11=APS. Table 2 illustrates one example of the ordering of a list of search query templates including such tests.

TABLE 2
Example of Search Query Templates Ordered Along Group and Word
Dimensions

| Search Query | |
|---|---|
| Template Label | Groups |
| SQT1A | POASW(R) |
| SQT1B | POASW(M) |
| SQT1C | POASW(C) |
| SQT2A | PAASW(R) |
| SQT2B | PAASW(M) |
| SQT2C | PAASW(C) |
| . . . | |
| SQT10C | PPOAW(C) |
| SQT1 | POAS |
| SQT2 | PAAS |
| . . . | |
| SQT10 | PPOA |
| SQT11A | APSW(R) |
| SQT11B | APSW(M) |
| SQT11C | APSW(C) |
| SQT12A | AOSW(R) |
| . . . | |
| SQT17C | OOPW(C) |
| SQT11 | APS |
| SQT12 | AOS |
| . . . | |

In a further example, recognized terms 135 also undergo individual textual search and classification, as illustrated in FIG. 5, to further order the search query templates and resulting search queries from approximately more specific to approximately more general. This may be particularly useful where more than one recognized term 135 matches the group 140 specified by the search query template, but where these terms, when individually textually searched, yield different numbers of corresponding documents. As an illustration, for the above example in which session context 300 included user query language “changing language from German to English fails,” suppose the term “english” alone returned 20 documents (resulting in an O(M) classification) and the term “german” alone returned 10 documents (resulting in an O(R) classification), and the term “language” alone returned 100 documents (resulting in an O(C) classification). In this illustrative example, the ordered search templates SQT6 are formulated, from approximately more specific to approximately more general, as:

1. SQT6A=(O(R)O(M)AS), yielding a search query S6A of “change” AND “german” AND “english” AND “fails”

2. SQT6B=(O(R)O(C)AS), yielding a search query S6B of “change” AND “german” and “language” AND “fails”

3. SQT6C=(O(M)O(C)AS), yielding a search query S6C of “change” AND “english” AND “language” AND “fails”

Although the above examples use search query templates and search queries (using the Boolean “AND” operator) that require mutual presence of the recognized terms 135 and/or unrecognized words 305 in a particular document, in order for that document to be returned as a document-in-play 160, in a further example, one or more factors other than such mutual presence is used in formulating search query templates and search queries and/or ordering the search query templates from approximately more specific to approximately more general. In a one such example, the order in which such recognized terms 135 and/or unrecognized words 305 appear in a document are also determinative of whether that document is returned as a document-in-play 160. In such an example, a search query template specified as “AW(R)O” is different from “OAW(R)” The former example requires an Activity term preceding a Rare Word preceding an Object term in a document in order for that document to be returned among the documents-in-play 160. The latter example requires an Object term preceding an Activity term preceding a Rare Word in order for that document to be returned among the documents-in-play 160.

In another example, the proximity between recognized terms 135 and/or unrecognized words 305 is also used as a criterion (either alone, or in conjunction with another criterion, such as order, for example) for formulating and/or ordering search query templates and/or search queries. In one such example, the search query template “Near (A, O, 3)” requires that an Activity term appear within 3 words of an Object term in a document in order for that document to be returned among the documents in play 160. In another such example, the search query template “Before (P, S, 2)” requires that a Product term appear before and within two words of a Symptom term in a document in order for that document to be returned among the documents-in-play 160. In one example, one or more search query templates using order and/or proximity specifications are used to approximate a linguistic relationship, such as a Subject/Verb or Verb/Object relationship approximated by an Activity and an Object or by a Symptom and an Object (e.g., “e-mail server crashes” or “install ActiveX”). In another example, a pair of Objects approximates a modifier relationship (e.g., “html authentication”). In a further example, a pair of Activities, or an Activity and a Symptom, approximates a subclause relation (e.g., “After I upgraded Windows 2000, SQL server stopped responding,” or “I couldn't burn a CD while transferring files”). In another example, user queries are parsed and these or other actual linguistic relationships are identified rather than merely being approximated using order and/or proximity specifications.

As an illustrative example, a search query template represented syntactically as “Verb_Object(A, Modifier(OO))S” requires a returned document-in-play 160 to include two Object terms from session context 300, one of which modifies the other, this pair of Object terms being the linguistic object of a verb Activity term from session context 300, and a Symptom term from session context 300 must also be present in the document. The search query template (Near(Verb_Object(A, Modifier(OO)),S, 5) further requires that the Symptom term from session context 300 must appear in the document within 5 words of both the Activity term from session context 300 and the pair of Object terms from session context 300, in order for that document to be returned among the documents-in-play 160. In one example, the order and/or proximity information and/or linguistic relations for a particular document is encoded, such as by autocontextualization engine 145A, into the document's tags to the recognized terms 135. In another example, the order and/or proximity information and/or linguistic relations for a particular document is encoded in an entry for each recognized term 135 in a textual search index.

In one embodiment, such as described above, the search query templates including order and/or proximity information are generally ordered at least approximately from more specific toward more general, for formulation of corresponding search queries (which substitute recognized and/or unrecognized terms in the user query language or other session context for the group or other dimensional attribute specified in the search query template) for execution in that fashion (or in a divide-and-conquer fashion) by retrieval engine 150. In one example, an algorithmic approach accommodates interactions between different dimensions (e.g., between the Activity, Object, Products and Symptoms dimension and the proximity dimension), to yield search query templates ordered from approximately more specific toward more general.

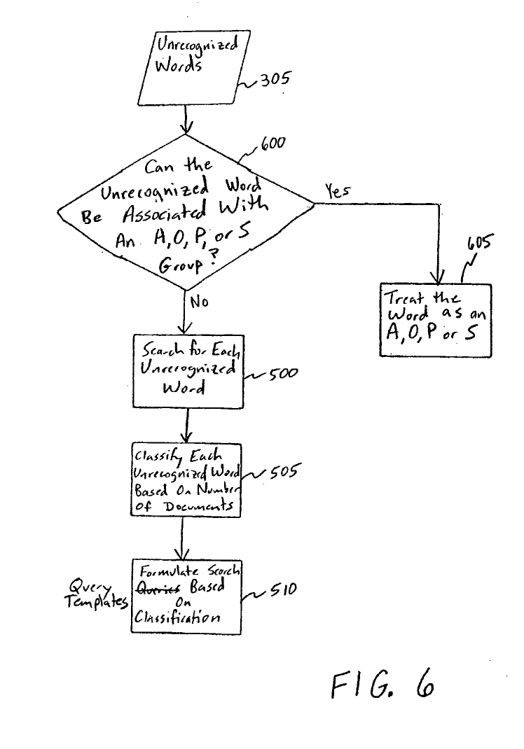

FIG. 6 is a flow chart illustrating generally, by way of example, but not by way of limitation one conceptualization of another approach to using unrecognized words 305 in the search query templates. At 600, a determination is made, for each unrecognized word 305 in session context 300, whether that word can be associated with one of the Activity, Object, Product, or Symptoms groups 140, such as by analyzing the linguistic structure of the user query. For example, from a user query of “I want to alphabetize my favorites,” it can be inferred that “alphabetize”0 is an Activity from the linguistic structure of the user query, because “I want to” is invariably followed by a verb. If, at 600, the unrecognized word 305 can be associated with one of the Activity, Object, Product, or Symptoms groups 140, then, at 605, that unrecognized word 305 is treated analogously to a recognized term 135 of the corresponding Activity, Object, Product, or Symptoms types, for example, using the search query templates listed in Table 1. Otherwise, the unrecognized word 305 is treated in the manner described above with respect to FIG. 5.

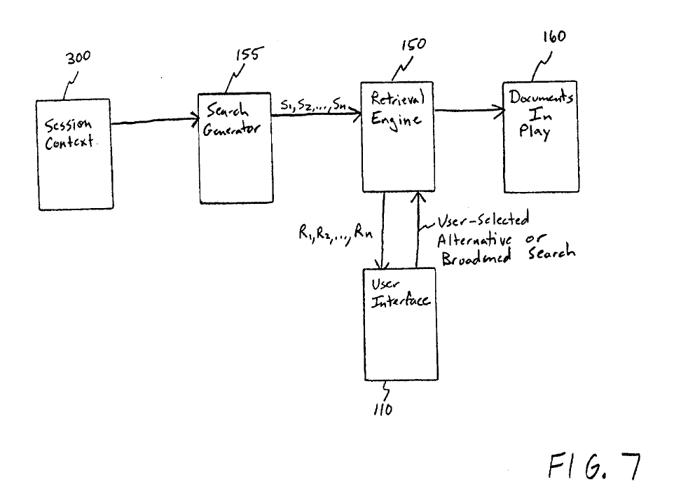

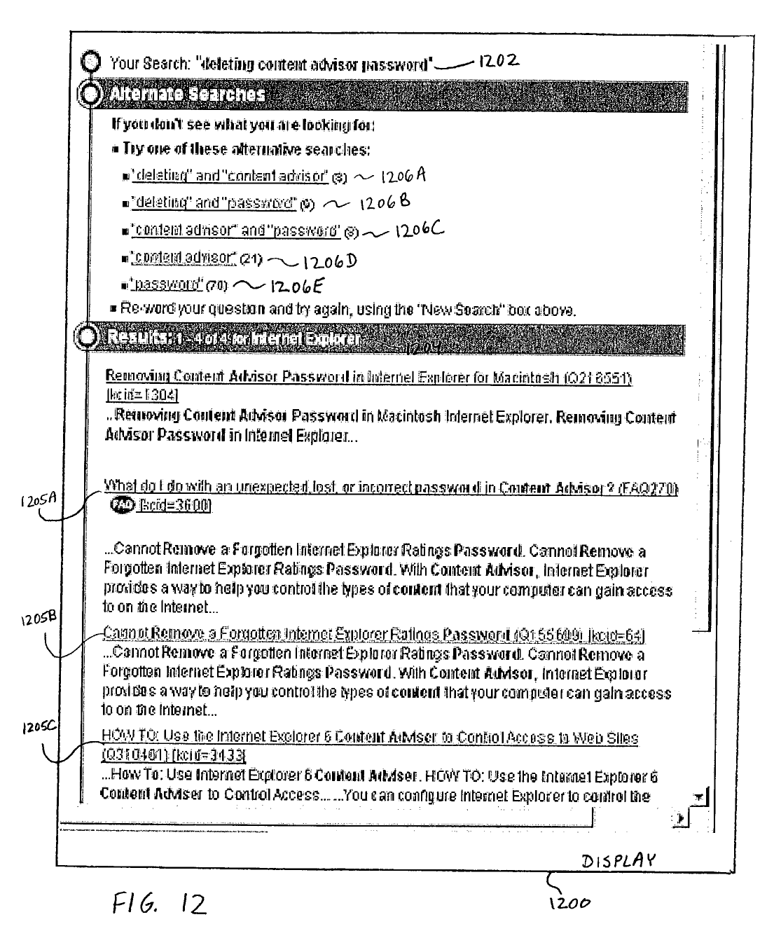

In one guided-search implementation, such as described and incorporated above, a user is presented indications of the returned documents-in-play 160. In one example of using the guided-search and retrieval techniques described in the above-incorporated Copperman et al. U.S. patent application Ser. No. 10/047,446, it is possible that no documents-in-play 160 are returned, or too few documents-in-play 160 are returned. As described therein, under such circumstances, the guided search presents one or more possible alternative or broadening search queries to the user 105. The various above-discussed embodiments of ordering search query templates (e.g., along a group dimension, a proximity dimension, an order of appearance dimension, using unrecognized words 305 as well as recognized terms 135, etc.) are, in one example, used to formulate alternative or broadening search queries to present to the user, as an alternative to, or in addition to, being used to perform retrieval. This is illustrated conceptually, by way of example, and not by way of limitation, in the block diagram of FIG. 7. In the example of FIG. 7, if a search using the guided-search techniques described in the above-incorporated Copperman et al. U.S. patent application Ser. No. 10/047,446 yielded no or too few documents-in-play 160, then alternative or broadening search queries S1, S2, . . . , SM are formulated by search generator 155 using session context 300, according to one or more of the techniques described above for generating such queries from search query templates that are ordered generally from approximately more specific toward more general. Retrieval engine 150 executes one or more such search queries, yielding results R1, R2, . . . , RM, which include the number of documents corresponding to each search query, but which need not identify or return the documents themselves. One or more indications of these alternate or broadening search queries and corresponding results are presented to user 105 via user interface 110, such as shown in the example of FIG. 12.

FIG. 12 is a screen shot illustrating a portion of a computer display 1200 included in the user interface 110. FIG. 12 illustrates an example with “deleting content advisor password” as the user query 1202 received from the user 105. In FIG. 12, the displayed number 1204 of document links 1205 to documents in play included in the search results (four documents in play were returned in this example) is less than a predetermined threshold number. This triggered formulation and display of alternate search query links 1206A-E. In FIG. 12, each alternate search query link 1206 is displayed together with its search terms (e.g., “deleting” and “content advisor”), and the number of documents in play that would be returned if that particular alternate search query were to be selected by the user 105. In this example, the alternate search query links 1206 are ordered prior to being displayed. The ordering is carried out using search query templates that are ordered along one or more dimensions, such as discussed above, from approximately more specific (yielding fewer documents in play) to approximately more general (yielding more documents in play). The user 105 can then select and/or edit a particular one or the alternate or broadening search query links 1206A-E, which search query is then executed by retrieval engine 150 to return an alternative or broadened set of documents-in-play 160.

In one example, information is displayed to the user 105 via user interface 110 according to one or more of the techniques described in the above-incorporated Copperman et al. U.S. patent application Ser. No. 10/07,446. In a further embodiment, session context is used to control one or more aspects of how information is displayed to the user 105 via user interface 110. In one such example, the particular type of group or groups 140 corresponding to recognized terms 110 (e.g., obtained from the user query language) at least partially determines at least one aspect of how information is displayed to the user 105.

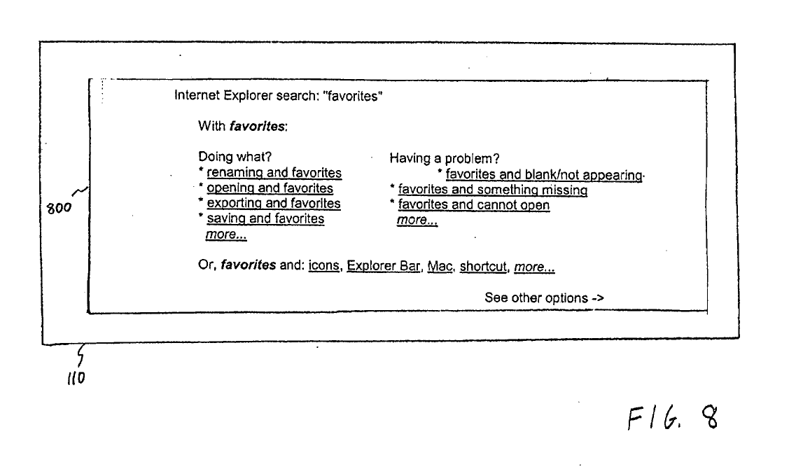

FIG. 8 is a schematic illustration of a portion of a display 800 of user interface 110, resulting from a user query that includes a single Object-type recognized term 135, i.e., the term “favorites.” In the illustrative example of FIG. 8, the resulting display includes links that suggest combinations of the Object “favorites” with various Activity terms (e.g., “renaming and favorites,” “opening and favorites,” etc.). Display 800 separately includes links that suggest combinations of the Object “favorites” with various Symptom terms (e.g., “favorites and blank/not appearing,” “favorites and something missing,” etc.). Display 800 separately includes links that suggest other Object terms that can be combined with “favorites” (e.g., “icons,” “Explorer Bar,” etc.). By selecting a particular link, user 105 can further constrain the search. By displaying such links that emphasize related Activities and related Symptoms that can be combined with the single Object term, display 800 is more effective at guiding user 105 to particularly relevant documents 120.

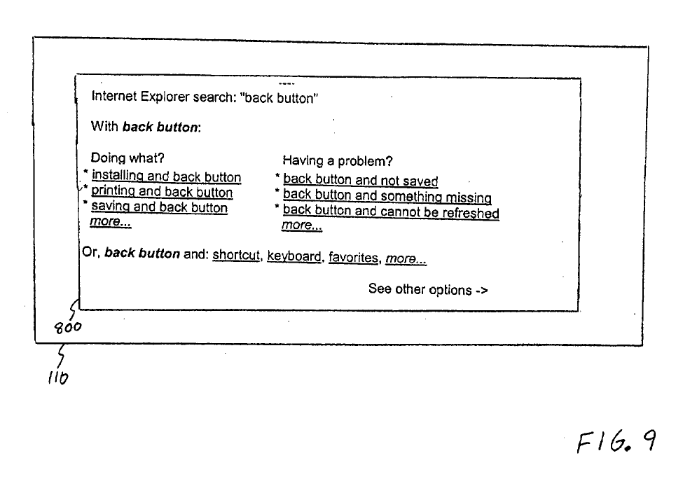

FIG. 9 is a schematic illustration of a portion of a display 800 of user interface 110, resulting from a user query that includes a single Object-type recognized term 135, i.e., the term “back button.” In the illustrative example of FIG. 9, the resulting display includes a group of links that suggest combinations of the Object “back button” with various Activity terms (e.g., “installing and back button,” “printing and back button,” etc.). Display 800 separately includes a group of links that suggest combinations of the Object “back button” with various Symptom terms (e.g., “back button and not saved,” “back button and something missing,” etc.). Display 800 separately includes links that suggest other Object terms that can be combined with “back button”(e.g., “shortcut,” “keyboard,” etc.).

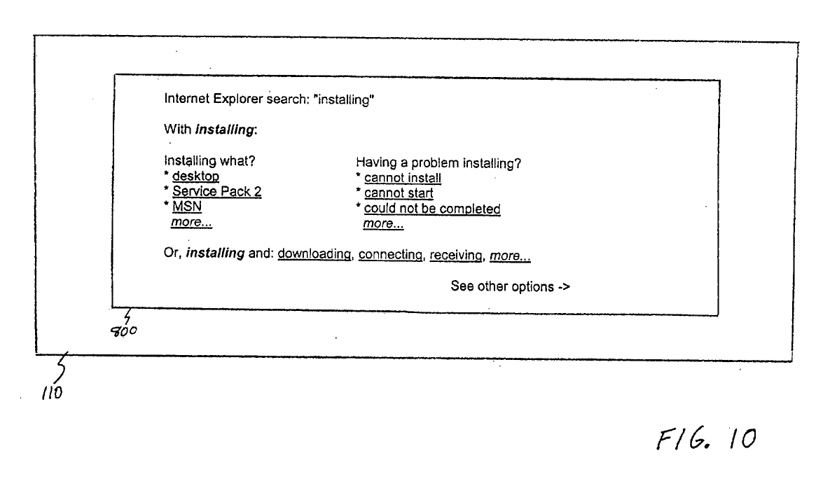

FIG. 10 is a schematic illustration of a portion of a display 800 of user interface 110, resulting from a user query that includes a single Activity-type recognized term 135, i.e., the term “installing.” In the illustrative example of FIG. 10, the resulting display includes a group of links that suggest combinations of the Activity “installing” with various Object and/or Product terms (e.g., “desktop,” “Service Pack 2,” etc.). Display 800 separately includes a group of links that suggest combinations of the Activity “installing” with various Symptom terms (e.g., “cannot install,” “cannot start,” etc.). Display 800 separately includes a group of links that suggest other Activity terms that can be combined with “favorites”(e.g., “icons,” “Explorer Bar,” etc.). By selecting a particular link, user 105 can further constrain the search. By displaying such links that emphasize related Objects/Products and related Symptoms that can be combined with the single Activity term, display 800 is more effective at guiding user 105 to particularly relevant documents 120.

In the examples of FIGS. 8 and 9, the single Object term display 800 is tailored for the case where additional focus is obtained by combining the Object with an Activity, and presents a question particular to that situation (e.g., “Doing what?”), or by combining the Object with a Symptom, with a different question particular to that situation. In the example of FIG. 10 , the single Activity term display 800 is tailored for the case where additional focus is obtained by combining the Activity with an Object, and presents a question particular to that situation (e.g., “Installing what?). In one example, the related terms are obtained from the derived groups described in the above-incorporated Copperman et al. U.S. patent application Ser. No. 10/0047,446.

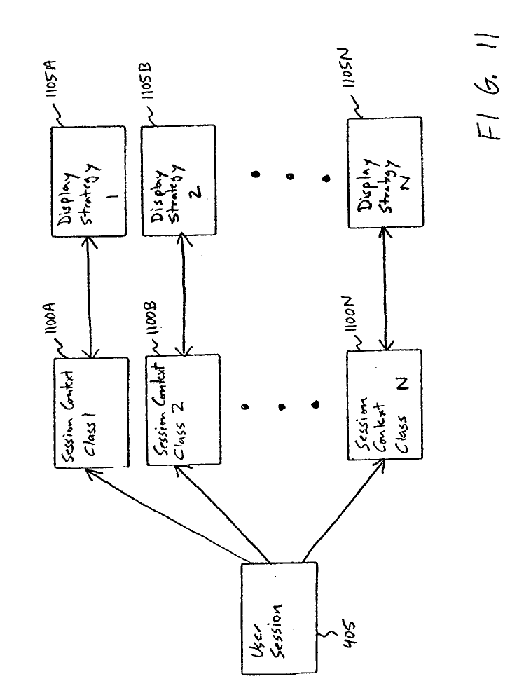

In a further example, a user query including both an Object-type recognized term 135 and an Activity-type recognized term 135 triggers a different display that is tailored toward more effectively guiding the search when such session context is present. More generally, as illustrated in the schematic diagram of FIG. 11, the session context is divided into classes 1100A-N, with each class 1100 capable of independently defining a display strategy 1105. In one example, the contextualized display classes are defined by one or more of the above-described combinations of groups 140 (e.g., O, A, OOAS, Near(Verb_Object(A, Modifier (OO)), S, 5), etc.), with associated presence, ordering, proximity, and/or other relational requirements on the terms represented by the groups.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects.

What is claimed is:

1. A content provider system, including:
a set of groups of term types;
a predetermined set of terms, organized into the groups;
a user interface, configured to interact with a user during a user-provider session that generates session context in which terms from the predetermined set of terms are recognized; and
a set of search templates, ordered generally from approximately more specific toward approximately more general, each search template specifying a combination of one or more of the groups;
a search generator, configured to use the session context for generating a search query from a corresponding search template, the search generator coupled to the user interface to present at least one of the search queries to the user; and
a retrieval engine, coupled to the search generator for receiving one or more search queries and retrieving documents satisfying the one or more search queries.

2. The system of claim 1, in which the search generator generates the search query from the corresponding search template by incorporating into the search query, for each group in the corresponding search template, language from the session context that must be present in a document in order for that document to satisfy the search query.

3. The system of claim 2, in which the retrieval engine is coupled to the user interface, the retrieval engine configured to receive one or more of the search queries from the search generator and to indicate to the user interface how many documents correspond to each of the one or more search queries.

4. The system of claim 3, in which the retrieval engine is configured to present to the user one or more of the search queries and the indication of how many documents correspond to each of the one or more search queries for the user to select a particular one of the search queries to initiate at least one of a broadening search and an alternative search.

5. The system of claim 1, in which at least one of the terms includes a set of a word and at least one synonym of the word.

6. The system of claim 1, in which the groups include at least one of an Activities group, an Objects group, a Symptoms group, and a Products group.

7. The system of claim 1, further including unrecognized word classification groups to permit classification of one or more unrecognized words in the session context as a member of one or more of the classification groups.

8. The system of claim 7, in which the classification uses a frequency with which the unrecognized word occurs in the documents accessed by the content provider system.

9. The system of claim 1, in which the session context is based on at least one of user query language, user response language, a user selection, and a user attribute.

10. The system of claim 1, further including at least one of a dialog engine and an autocontextualization engine, the at least one of the dialog engine and the autocontextualization engine configured to generate the session context.

11. The system of claim 1, in which at least one of the search templates also specifies at least one relation between groups associated with the at least one of the search templates.

12. The system of claim 11, in which the at least one relation specifies an order between at least two of the groups specified by the search template, such that a resulting search query requires that language from the session context appear in the document in the specified order to satisfy the search query.

13. The system of claim 11, in which the at least one relation specifies a proximity between at least two of the groups specified by the search template, such that a resulting search query requires that language from the session context appear in the document in the specified proximity to satisfy that search query.

14. The system of claim 11, in which the at least one relation specifies a linguistic relation between at least two of the groups specified by the search template, such that a resulting search query requires that language from the session context appear in the document in the specified linguistic relation to satisfy that search query.

15. The system of claim 1, in which the search template specifies a frequency with which language from the session context must be present in the document to satisfy a resulting search query generated from that search template.

16. The system of claim 1, in which the user interface includes a display configured to present at least one of the search queries to the user to trigger at least one of a broadening search and an alternative search.

17. The system of claim 1, in which the user interface includes a display configured to present at least one of the search queries to the user to trigger a narrowing search.

18. The system of claim 1, in which the user interface includes a display configured to display to the user search queries ordered using the ordering of the search templates.

19. The system of claim 1, in which the user interface includes a display capable of being formatted at least in part using which one or more groups language in the session context belongs to.

20. The system of claim 1, in which the user interface includes a display capable of being formatted at least in part using which one or more groups one or more terms present in user query language belong to.

21. The system of claim 1, in which the user interface includes a display capable of being formatted at least in part using whether only one term is present in user query language and whether that term is an Activity, Object, Product, or Symptom.

22. The system of claim 1, in which the user interface includes a display capable of being formatted at least in part using an ordering in user query language of groups that correspond to terms that are present in the user query language.

23. The system of claim 1, in which the user interface includes a display capable of being formatted at least in part using a proximity in user query language of groups that correspond to terms that are present in the user query language.

24. The system of claim 1, in which the user interface includes a display configured to present search queries to the user after filtering out search queries that yield no corresponding documents and after ranking the search queries using the ordering of the search templates from which the search queries are generated.

25. A computer-assisted method of guiding a user toward needed content, the method including:
engaging a user in a user-provider session that generates session context;
recognizing whether one or more predetermined terms are present in the session context; and
formulating a set of search queries, ordered generally from approximately more specific toward approximately more general, using a set of search templates that are ordered generally from approximately more specific toward approximately more general.

26. The method of claim 25, in which each search template specifies a combination of one or more groups selected from a plurality of predetermined groups, and in which the one or more predetermined terms that are present in the session context include a type that determines whether it is a member of one of the predetermined groups, and in which the formulating the set of search queries includes, for a particular search query, matching session context to a combination of one or more groups specified by a corresponding search query template, such that the matched session context must be present in a document in order for that document to satisfy the search query.

27. The method of claim 26, further including:
presenting search queries to the user; and
indicating to the user how many documents correspond to each of the search queries presented to the user.

28. The method of claim 27, in which the presenting search queries to the user includes presenting a choice between different search queries to the user as part of an alternative search or a broadening search.

29. The method of claim 26, in which at least one group corresponds to words that occur in the content with a specified frequency.

30. The method of claim 26, further including classifying an unrecognized word in the session context into one of the groups using a frequency with which the unrecognized word occurs in the content.

31. The method of claim 26, in which each at least one of the search templates also specifies at least one relation between groups associated with the at least one of the search templates.

32. The method of claim 31, in which the at least one relation specifies an order between at least two of the groups specified by the search template, such that a resulting search query requires that language from the session context appear in the document in the specified order to satisfy that search query.

33. The method of claim 31, in which the at least one relation specifies a proximity between at least two of the groups specified by the search template, such that a resulting search query requires that language from the session context appear in the document in the specified proximity to satisfy that search query.

34. The method of claim 31, in which the at least one relation specifies a linguistic relation between at least two of the groups specified by the search template, such that a resulting search query requires that language from the session context appear in the document in the specified linguistic relation to satisfy that search query.

35. The method of claim 25, further including displaying to the user search queries ordered using the ordering of the search templates.

36. The method of claim 25, further including formatting a display at least in part using which one or more groups language in the session context belongs to.

37. The method of claim 25, further including formatting a display at least in part using whether only one term is present in user query language and whether that term is an Activity, Object, Product, or Symptom.

38. The method of claim 25, further including formatting a display at least in part using an ordering in user query language of groups that correspond to terms that are present in the user query language.

39. The method of claim 25, further including formatting a display at least in part using a proximity in user query language of groups that correspond to terms that are present in the user query language.

40. The method of claim 25, further including displaying search queries to the user after filtering out search queries that yield no corresponding documents and after ranking the search queries using the ordering of the search templates from which the search queries are generated.

41. The method of claim 25, further including retrieving one or more documents satisfying at least one of the search queries.

42. The method of claim 25, in which the groups include at least one of an Activities group, an Objects group, a Symptoms group, and a Products group.

43. The method of claim 25, in which the engaging the user in a user-provider session that generates session context includes obtaining session context from at least one of user query language, user response language, a user selection, and a user attribute.

44. The method of claim 25, in which at least one of the terms includes a set of a word and at least one synonym of the word.

45. The method of claim 25, further including obtaining the session context using at least one of user query language, user response language, a user selection, and a user attribute.

46. A computer readable medium including instructions for performing the method of claim 25.
